(19) United States
(12) Patent Application Publication
(10) Pub. No.: US 2017/0366710 A1
(43) Pub. Date: Dec. 21, 2017

(54) Safe Cycle Cam

(71) Applicants: Paul L. Vaughn, Curryville, MO (US); Terri Collins, Curryville, MO (US)

(72) Inventors: Paul L. Vaughn, Curryville, MO (US); Terri Collins, Curryville, MO (US)

(21) Appl. No.: 15/185,293

(22) Filed: Jun. 17, 2016

(51) Int. Cl. H04N 5/225; H04N 5/247; H04N 5/232

(52) U.S. Cl. CPC H04N 5/2252; H04N 5/23241; H04N 5/247

(57) ABSTRACT

A device mounted on a helmet for monitoring and recording of rear and front view in real-time that includes a pair of electronic cameras and a non-volatile storage module removably attached to the device. The storage module is operably connected to the pair of cameras for storage of video data in real-time. A display unit communicatively coupled to the pair of cameras disposed on a front facing unit of the device with control switches for exhibiting stream of rear view in real-time and a USB port is also disposed on the device for providing an interconnection of the device to a plurality of external communicating devices for transmission of recorded data and also aids in charging of the device and a power supply mounted on the device for providing driving power to the pair of cameras and the display unit. The plurality of control switches for control of recording and power supply to the cameras and display unit. The device further comprises an adjustable strap for fixing the device conveniently on the helmet unit.

### CROSS REFERENCE TO RELATED APPLICATIONS

Not applicable

### FEDERALLY SPONSORED RESEARCH AND DEVELOPMENT

Not applicable.

### BACKGROUND OF THE INVENTION

### Field of the Invention

The present invention generally relates to a mounting device mounted on the outer top surface of a helmet for monitoring and recording of rear and front views in real-time and reproducing the rear view on the display unit in front of the wearer.

### Background of the Invention

With the advancements in electronics video capturing technologies by reducing its size, increasing efficiency and reducing cost, people are frequently using video cameras to capture their experiences and for analysis purposes also. A camera mounted on the front facing of a helmet can provide exciting experiences for users involved in many activities from sports to industries for instance in sky diving, riding, skiing, diving, jumping as well as working in mines or in tunnels. By providing camera can record their each and every movement and can transmit it to at least one peripheral device by communication means. But by providing camera only in one direction is not self-sufficient to capture all the necessary information. With this requirement the concept of dual cameras were introduced. One additional camera unit inserted on the rear side of the head mounted devices such as helmets to capture the rear view.

Many improvements have been developed to help in making a rider capable of view both front and rear views simultaneously through a head mounted device. For example, U.S. Pat. Appl. No. 20080239080A1 issued to Jonathan D. Moscatoon, discloses a rear vision system for vehicles, for providing a rider of a bicycle, motorcycle, or any driven vehicle with the capability of viewing the road behind his vehicle while facing forward, without requiring his head to be in a predetermine position.

Similarly, U.S. Pat. Appl. No. 20090109292A1 issued to Motocam 360, discloses a protective housing that can be secured atop a helmet with a plurality of image sensors disposed therein. The image sensors may be oriented in a plurality of directions for simultaneous capture of image data. A multi-channel flexible cable can emerge from said protective housing, said cable adapted to carry image signals from the image sensors to an image recording and/or image display device. A variety of attaching means may be used to secure the protective housing atop a helmet or other host, such as the roof of a car, as will be appreciated.

Similarly, U.S. Pat. No. 8,531,592 B2 issued to Wilcox Industries Corp, discloses a recording module removably attached to the head gear and adapted to receive the video signal and store data representative of the video signal; a camera module attachable to the head gear, including a first video camera integrated into the camera module for generating a video signal; a power supply module removably attachable to the head gear and electrically connectable to said camera module and to said recording module; and a light module integrated with said camera module and electrically coupled to said power supply module, wherein said first camera module and said light module are each pivotable about a common pivot axis which extends-transversely with respect to an optical axis of said first video camera.

These models increased the overall cost and complexity manifolds. Almost every rider or other person in their field of interest having necessary safety means like helmets and purchasing a new helmet for recording purposes seems unfeasible to the users.

It is an aspect of the invention to overcome or alleviate a problem of the prior art. This permits the use of the present invention which enhance the prior art of the system of viewing in real-time the rear view of the vehicle system while driving and simultaneously recording the front and rear views captured by the pair of cameras.

### SUMMARY OF THE INVENTION

In view of the foregoing, one aspect of the various disclosed embodiments in the present invention is to provide a system for disposing a device on the top of a helmet to make it capable of monitoring and recording rear and front view and also displaying rear view in real time with the help of a pair of cameras and a display unit.

Preferably the system addresses, or at least improves one or more of the problems described above. To this end, the present invention relates to a method for viewing rear view in real time while focusing only in forward direction without looking back while riding a two wheeler.

Accordingly, it is a primary object of the present invention to provide a device mounted on the outer top surface of a helmet for monitoring and recording of rear and front view in real-time and streaming rear view in front of the helmet wearer on the display unit fitted therein, that includes a pair of electronic cameras and a non-volatile storage module removably attached to the device. The storage module is operably connected to the pair of cameras for storage of data provided by cameras in real-time. A display unit that is communicatively coupled to the pair of cameras disposed on a front facing unit of the device with control switches for exhibiting stream of rear view recorded video in real-time and a USB port is also disposed on the device for providing an interconnection of the device to a plurality of peripheral communicating devices for transmission of recorded data and also aids in charging of the device. The plurality of control switches for controlling plurality of operations such as recording and power supply to the cameras and display unit. The device further comprises an adjustable strap for fixing the device conveniently on the helmet unit.

It is another object of the present invention to provide cameras in both front and backwards directions to track the activities of vehicles running behind thus increasing the safety by avoiding accidents.

It is still another object of the present invention that the display unit can be mounted at any angular position in front of the user to provide a clear view of the rear side while not obstructing the front view. The height of display unit is provided an adjustable mechanism that provides the best configuration for different users and also depending on dimensions of their faces.

It is yet another object of the present invention that provides the rear view on the display unit in such a manner that does not create much distraction while focusing on the road side and this objective is achieved by displaying the rear view on a small portion of the visor unit.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front side view and rear side view of the mounting device on the helmet.

FIG. 2 is a front view of the helmet mounted with the device provided with a display unit.

FIG. 3 represents a side view of the helmet mounting device.

FIG. 4 represents a bottom view of the helmet mounting device.

### DETAILED DESCRIPTION OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

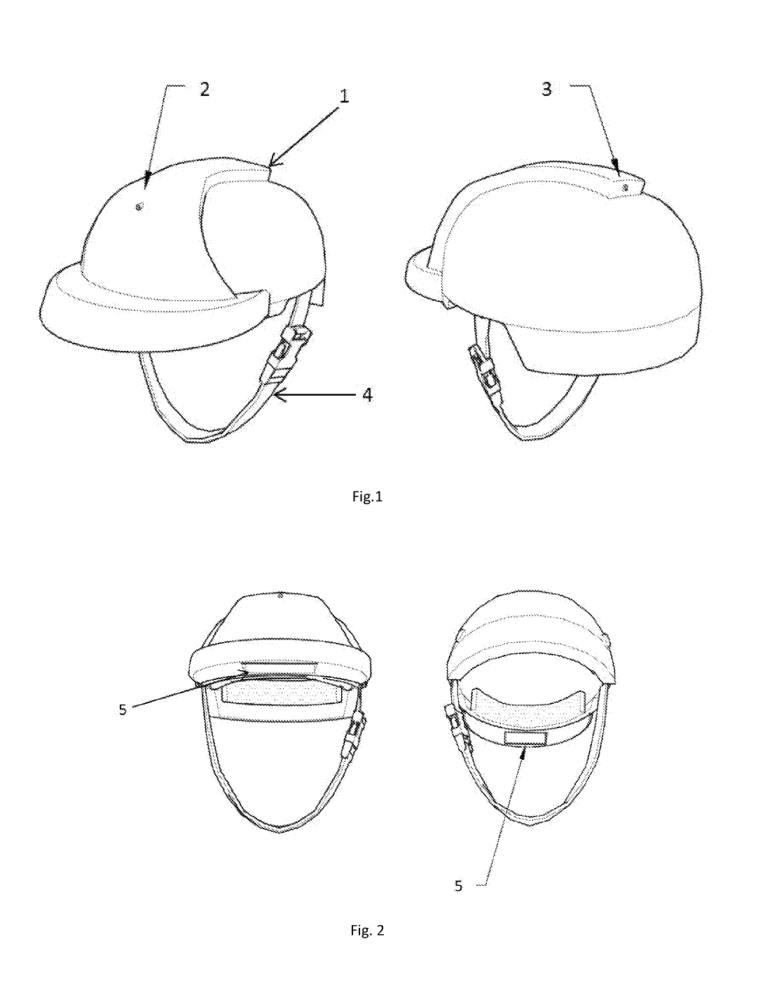

Referring to FIG. 1 describes a front side view and rear side view of a mounting device (1) on the helmet in two different arrangements. The mounting device (1) or device is embedded with two electronic cameras affixed in two opposite directions. The front facing unit is disposed with a front electronic camera (2) and rear facing unit is disposed with a rear electronic camera (3) that are communicatively coupled to a display unit. An adjustable flexible strap (4) is also provided on the device so affix the device with the helmet unit in a convenient manner. The length of the strap (4) can be varied depending on the user requirements and it can be fixed immediately by using a lock and release mechanism. The strap (4) is generally constructed from polymers of nylon or similar materials to bear the required strength and tension.

FIG. 2 referring a front view of the helmet mounted with the device provided with a display unit. The display unit (5) is generally disposed on the front facing unit of the mounting device. The front facing unit is holding the display unit (5) that is removably attached to the front facing unit in a groove. The two electronic cameras are designed to record a front and rear views and in the same time streaming the rear view in the display unit (5). This arrangement assists the wearer to have a clear picture of the rear view with turning and looking back. The device is constructed specially from shock absorbing materials to absorb shocks and to provide hassle free operation of the device during mounting on the helmet.

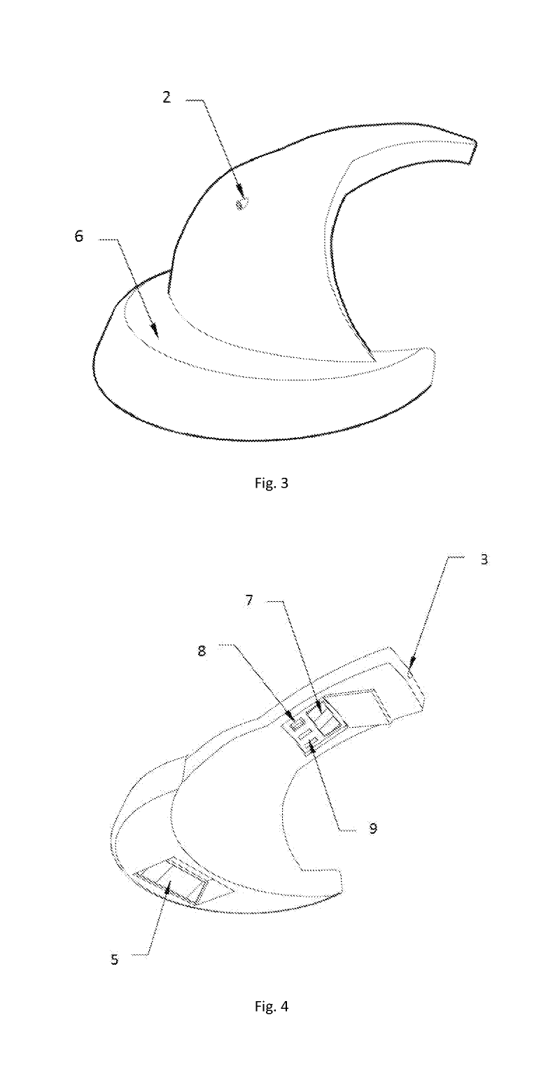

FIG. 3 represents a side view of the helmet mounting device flashing front camera (2) and a visor (6). The mounting device constructed from a hard end plastic material that is capable of handling shock and jerks. The front facing camera (2) is affixed on the device that should remain at some height as compared to the display unit. This structure can vary in a number of designs to incorporate with the helmet designs to be fitted suitably on helmet's top side.

In one of the embodiment of the invention the display unit is constructed on the one side portion of the visor to provide both front and rear view simultaneously. By doing this less eye movement will be required to make a look at the rear view that leads to less distraction and more safety during motion. The selected portion visor is transformed into display unit.

In one other embodiment of the invention the display unit can be a fixed display unit that is fixed at an angular position with respect to the position of the eyes of wearer to make a clear view without much distraction.

FIG. 4 represents a bottom view of the helmet mounting device disclosing various components of the invention. The mounting device incorporating the rear camera (3) on rear facing unit, a display unit (5) on front facing unit and a control box further comprising a power supply (7), a universal serial bus (8) and SD card slots (9). The display unit (5) mounted on an angular position with respect to the wearer to make a clear view. The height of the display unit may be adjusted in accordance with the user requirements. The power supply (7) comprises a series of batteries to supply the necessary driving power to the camera units and display unit as well. The USB (8) port is provided to supply external electric charging to the device and also it aids in communication with external communication devices over different communication protocols. The USB (8) is also serves the purpose of transferring a video data from the SD card slots (9) to peripheral computing devices. The SD card slots (9) were designed to record the video data captured by the front and rear cameras in real-time and also provides the same to the display unit (5). The display unit (5) can be of any type preferably selected from CSTN (Color Super Twisted Nematic), TFT (Thin Film Transistor), TFD (Thin Film Diode), OLED (Organic Light-Emitting Diode), AMOLED display (Active-matrix organic light-emitting diode), Capacitive, and Resistive.

The storage capacity of the device can be expanded up to a certain limit by making some hardware changes accordingly. The arrangements of both the cameras are 180° out of phase with respect to each other. The cameras can be controlled remotely or with a plurality of control switches provided on the device to perform various operations like recording, power supply, and brightness adjustment of the display unit etc. to achieve the objective of the invention.

In one of the preferred embodiment of the invention the mounting device can be configured with a global positioning system (GPS) that assists the wearer with various route maps by showing maps from time to time to reach the destination and nearby places also.

In yet another embodiment of the invention the device can be configured with a voice interface that may be capable enough to generate and receive voice commands to and from the wearer simultaneously to perform various control operations.

In one another embodiment of the invention the cameras can be fitted with a night vision system that enables to record the night view clearly and this arrangement helps users to ride his vehicle in night time without any problem.

In one another embodiment of the invention the cameras can be fitted with thermal imaging cameras that assist in locating the objects in the less ambient environment on the basis of their temperature.

In one another embodiment of the invention the display unit can be touch operated having all control switches buried on the touch display.

In one another embodiment of the invention the cameras can be mounted in any direction and can have a fixed as well as a rotatable configuration about their own axis up-to a certain angular limit and covering a complete 360° view collectively around the vehicle.

In one another embodiment of the invention the flexible strap can have elastic properties that enables it to be adaptively affixed with the helmet configurations using a male and female locking connectors or by other possible means also.

In yet one another embodiment of the invention the device can be fitted with proximity a plurality of sensors in both front and rear facing units that provides the distance in meters or centimeters of the objects preferably other vehicles that are in close proximity of the wearer.

Accordingly, the specific embodiments discussed herein are merely illustrative of specific manners in which to make and use this invention, and are not intended to represent an exhaustive list of all possible structure and processes of the present invention.

Embodiments of the system for storing and retrieving contact information in a communication device are discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

The present invention provides a system to provide a real-time rear view data displayed on the display located in front of the wearer using a rear camera and at the same time the front camera keep on recording the front view of the camera. The recorded data gets stored in the storage modules that can be further connected to the communicating devices to exchange data.

The whole structure also protected by a water proofing unit to make it efficient in rainy season also. The arrangements of cameras can be adjusted by a rack and pinion arrangement to any height and any angular position desired by the wearer. The storage media should include a non-volatile memory that can be selected from a group of ROM, PROM, EPROM, EEPROM, MROM, flash memory, solid state storage. The memory capacity can be expandable and different modules can have different configurations and storage capacity is also one of that requirements.

This arrangement provides safety to the wearer and the wearer can easily see the rear view in real time without buying a new helmet. A user can easily affix the device on the helmet with the help of connecting means. The connection mechanism can be any type of joint mechanism such as coupling, interlocking, pressure locking etc.

The device is constructed from a high end plastic that is strong enough to bear shocks and jerks during motion without distorting the performance of the whole arrangement.

The device captures live recording of the front and rear cameras and the recorded video data can be downloaded by connecting the device with peripheral communicating devices selected from the group of cellular phone, laptop, palmtop, PDA, computers, mobile data devices capable of receiving and transmitting RF signals and combination thereof with the help of USB port. The USB port aids in transfer of data from the device to peripheral devices in accordance with the data transfer protocols.

This device can be beneficial for motorcyclists, military personnel's or for all persons that already have a helmet and having the intention of covering rear view without looking back by turning their neck back.

The cameras consume power supplied by the power supply that is mounted in the device and the rechargeable batteries can be inserted to charge these multiple times by connecting the device with the external supply unit through USB port.

While the above description regarding illustrative embodiments of the disclosed system includes examples of specific mounting devices, the present invention is not limited to those specific examples.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the above-given embodiments, it should be understood that other and further modifications, apart from those shown or suggested herein, may be made within the spirit and scope of this invention.

We claim:

1. A device mounted on a helmet for monitoring and recording of rear and front view in real-time, the device, comprising:
a pair of electronic cameras removably attached to said device;
a storage module removably attached to said device and operably connected to said pair of cameras;
a display unit disposed on a front facing unit of said device for exhibiting live stream of rear view;
a USB port disposed on said device for providing an interconnection of said device to a plurality of electronic communication devices; and
a power supply mounted on said device for providing driving power to said pair of cameras and said display unit.

2. The system as claimed in claim 1, wherein said pair of cameras removably mounted on front and rear facing units of said device in 180° out of phase.

3. The system as claimed in claim 1, wherein said storage module comprises a non-volatile storage device for storing a video data provided by said pair of cameras in real-time.

4. The system as claimed in claim 1, wherein said display unit is communicatively coupled to said pair of cameras.

5. The system as claimed in claim 1, wherein said display unit is removably affixed at an angular position on said front facing unit of said device.

6. The system as claimed in claim 1, wherein said display unit is provided with a plurality of control switches.

7. The system as claimed in claim 6, wherein said plurality of control switches, controls various operations selected from the group of recording, power supply, display brightness, contrast and combination thereof.

8. The system as claimed in claim 1, wherein said display unit provides the streaming of rear view from said rear camera in real-time.

9. The system as claimed in claim 1, wherein said USB provides exchange of said video data from said device.

10. The system as claimed in claim 1, wherein said USB aids in charging of said device from external supply.

11. The system as claimed in claim 1, wherein said plurality of electronic communication devices selected from the group of cellular phone, laptop, palmtop, PDA, computers, mobile data devices capable of receiving and transmitting RF signals and combination thereof.

12. The system as claimed in claim 1, wherein said device further comprises an adjustable helmet strap for affixing said device with said helmet.

13. A wireless head mounted monitoring device comprising:
a pair of cameras mounted in opposite directions to each other on said device;
a display unit electrically coupled to said pair of cameras;
a power source housed in said device;
a USB port for providing connections to and from external circuits; and
a pair of control switches for performing control operations.

14. The system as claimed in claim 14, wherein said display unit mounted on a front facing unit of device below a front camera.

15. The system as claimed in claim 14, wherein said pair of control switches controls recording and power supply.
